(19) United States
(12) Patent Application Publication
(10) Pub. No.: US 2008/0177661 A1
(43) Pub. Date: Jul. 24, 2008

(54) SYSTEM AND METHODS FOR PHONE-BASED PAYMENTS

(76) Inventor: Divya Mehra, Framingham, MA (US)

Correspondence Address: FISH & RICHARDSON, PC, P.O. BOX 1022, MINNEAPOLIS, MN, 55440-1022, US

(21) Appl. No.: 11/625,570

(22) Filed: Jan. 22, 2007

(51) Int. Cl. G06Q 20/00; G10L 21/00

(52) U.S. Cl. 705/44; 704/270; 704/E17.002; 704/E17.001; 704/E15.001

(57) ABSTRACT

This specification describes technologies relating to a phone-based payment system for transferring funds between payers and payees, and methods of providing such a system. In general, one aspect is implemented as a method of electronic payment that includes receiving a payer identifier from a payer, and the payer identifier is selected from a group of a registered phone number and a registered business server identifier. The method also includes identifying the payer as an authorized user based on the received payer identifier. The method further includes authorizing a payment transfer from a bank account of the payer to a bank account of a payee if the identified payer is an authorized user. Other implementations of this aspect include corresponding systems, apparatus, and computer program products.

### BACKGROUND

The subject matter described herein relates to a phone-based payment system for transferring funds between payers and payees, and methods of providing such a system.

Payment or funds transfer systems that are currently available include paper-based payment systems and electronic funds transfer (EFT) based payment systems. Paper-based payment systems typically are based on a payer (i.e., the party that pays value in a payment transaction, such as a customer or consumer) writing a check, sending a money order or giving cash to a payee (i.e., the party that receives value in a payment transaction, such as an individual, merchant, or service provider).

For example, checks (and money orders) require the payer to pay postage and spend time to write and mail the check. The transit time of the postal service can delay receipt of funds. Sending the check faster than usual, such as by priority mail rather than first class mail, can incur additional mailing costs. Upon receipt, the payee has to physically deposit the check via a bank teller or an ATM. Moreover, banks have to maintain infrastructure to process these checks. The Check Clearing for the 21^{st} Century Act (“Check 21”) has removed the requirement to move paper checks from the payee's bank to the payer's bank. Instead, during the check clearing process, the payee's bank can capture a picture of the front and back of the check, along with the associated payment information, and transmit this information electronically to the payer's bank. This reduces the cost of physically handling and transporting checks, which can be very expensive. However, Check 21 only addresses the processing cost after the check has been deposited by the payee, not the inherent inefficiency in sending and depositing a check.

EFT-based payment systems have been gaining popularity and steadily replacing paper-based payment systems due in part to the inefficiencies of paper-based payment systems. EFT-based payment systems, such as direct deposit, pre-authorized payments, electronic check conversion at the point of sale, online or Internet banking, speed up the payment process considerably. For example, an individual who wishes to transfer money from his account in Bank A to his account in Bank B typically logs in to his Bank B account and enters his request to transfer funds from Bank A, by supplying Bank A's routing number and his Bank A account number. Typically, his Bank A account information needs to be registered and stored with Bank B beforehand. Bank B then initiates what is known as an Automated Clearing House (ACH) debit transaction, in which the funds are withdrawn from Bank A via an ACH operator.

A common application of conventional EFT-based payment systems is pre-authorized automatic EFT, which typically requires one party, e.g., a customer (i.e., the payer), to provide bank/credit account information to another party, e.g., a merchant (i.e., the payee), who typically stores such account information for later use during EFT transactions. With an EFT agreement in place, a customer can then have funds directly withdrawn from or charged to her bank or credit card account to pay a bill from the merchant, such as a utility company, given the customer provided information about her bank or credit card account to the merchant pursuant to the EFT agreement.

### SUMMARY

The present inventor recognized the deficiencies with conventional EFT-based and paper-based payment systems. For example, with conventional EFT-based payment systems, storing customers' sensitive bank or credit card account information by merchants can be a security risk because merchants can misplace customers' account information or have such information unknowingly taken from them. Uncontrolled dissemination of such account information increases risk of fraud, which often requires a significant expense to investigate. Additionally, registering a bank or credit card account with several merchants can be cumbersome for the customer because, for example, if any account information changes or the customer decides to change linked accounts, then the customer has to remember and update all the relevant records with each merchant.

Furthermore, Internet-based EFT payment systems require Internet access. Often, people do not have Internet access but have phone access (either a landline-based telephone or a mobile phone). Moreover, a quick phone call and ensuing voice interaction is generally faster than connecting to the Internet and typing data into a wireless device. Also, Internet-based EFT payment systems, such as online banking, face security threats from spyware programs which get installed on a user's computer due to deficiencies in the design of the computer's operating system or lack of user awareness. These spyware programs can log keystrokes and send this information over the Internet. Thus, sensitive login and password information can be sent to fraudsters without the user's knowledge. Consequently, the present inventor developed a flexible, efficient, easy to use, and secure phone-based payment system, which, for example, offers the flexibility of paying from a mobile or land-line phone, does not require the payer or the payee to remember or store the other party's account numbers, facilitates direct transfer of funds between the payer's and the payee's actual bank or credit card accounts (requiring neither the payer nor the payee to store funds with an intermediary), and does not require synchronization between the payer and the payee.

In one aspect, a method of electronic payment includes receiving a payer identifier from a payer, and the payer identifier is selected from a group of a registered phone number and a registered business server identifier. The method also includes identifying the payer as an authorized user based on the received payer identifier. The method further includes authorizing a payment transfer from a bank account of the payer to a bank account of a payee if the identified payer is an authorized user. Other implementations of this aspect include corresponding systems, apparatus, and computer program products.

Variations may include one or more of the following features. For example, the method of electronic payment can include receiving a payment request from the payee. The method can also include receiving an authentication based on a server voice identifier, and the server voice identifier includes a prerecorded voice message provided by the payer. Receiving an authentication can include receiving a personal identification number (PIN) and verifying the received PIN. The method can include receiving an authentication of the payee based on a transaction voice identifier, and the transaction voice identifier includes a prerecorded voice message provided by the payee. The method can also include receiving a payee identifier, and the payee identifier is selected from a group of at least a registered phone number and a registered business server identifier.

The method of electronic payment can include registering a phone having a caller identification (ID) or a business server having an identifier. The method can also include receiving a call from the registered phone, and the call is used to retrieve a bank identifier. The bank identifier can uniquely identify the bank of the payer. The method can include receiving a connection request from the business server through a communications network. The business server can be a software application or an electronic device associated with a business entity. Identifying the payer as an authorized user can include searching one or more records for a stored payer identifier matching the received payer identifier, and retrieving a record from the one or more records in which the received payer identifier matches with the stored payer identifier. The bank account of the payer or the payee can be an account selected from a group of a bank, a credit card company, a savings and loan, a mutual fund company, a brokerage firm, an insurance company and a credit union.

In another aspect, a method of electronic payment includes storing an identifier associated with a payer or a payee. The method also includes authorizing a connection from the payer or the payee based on the identifier. The method further includes transmitting a server voice identifier, and the server voice identifier includes a prerecorded voice message provided by the payer. The method additionally includes transmitting a transaction voice identifier, and the transaction voice identifier includes a prerecorded voice message provided by the payee.

Variations may include one or more of the following features. For example, the method can include authorizing a payment transfer from a bank account of the payer to a bank account of the payee based, at least in part, on the transaction voice identifier. The method can also include receiving an authentication based on the transmitted server voice identifier. The server voice identifier is used by a user to authenticate the central server. The method can further include receiving an authentication of the payee based on the transmitted transaction voice identifier.

In a further aspect, an electronic payment system includes a central server, a payer bank server configured to communicate with the central server, and a payee bank server configured to communicate with the central server. In one variation, the central server of the electronic payment system can be configured to store an identifier associated with a payer or a payee and authorize a connection from the payer or the payee based on the identifier. The central server can also be configured to transmit a server voice identifier, and the server voice identifier comprises a prerecorded voice message provided by the payer. The central server can further be configured to transmit a transaction voice identifier, and the transaction voice identifier comprises a prerecorded voice message provided by the payee.

Computer program products, which may be embodied on computer readable-material, are also described. Such computer program products may include executable instructions that cause a computer system to conduct one or more of the method acts described herein. Similarly, computer systems are also described that may include one or more processors and a memory coupled to the one or more processors. The memory may encode one or more programs that cause the one or more processors to perform one or more of the method acts described herein. These general and specific aspects may be implemented using a system, a method, or a computer program, or any combination of systems, methods, and computer programs.

The subject matter described herein may provide one or more of the following advantages. A payer can transfer funds by phone without having to tediously write and mail checks or having to know the account number of the payee. A payer also can make payments on-the-go, without having to access the Internet or go to a bank for assistance with the payment transaction. Similarly, other types of users can get real-time stock quotes and make real-time trades from a brokerage account using phone without having to speak to their broker.

Given the subject matter described herein permits funds transfers directly between the bank accounts of payers and payees without using an intermediary (e.g., Paypal) to store funds, payees (or other types of users) get faster access to funds in their bank accounts, can earn interest on these funds as these funds are not kept by the intermediary, and are not exposed to risks of any accounting errors or adverse actions by the intermediary. Further, robust verification can be obtained because the issuing bank or other financial institution, rather than the intermediary, initiates the registration of the user. Thus, the identity of the user can be verified prior to completion of the registration process, which can reduce fraudulent user registration directly through an intermediary's own website.

Additionally, a scalable payment system can be implemented because a user's record is identified by her unique phone number, and a bank identifier associated with the user's particular financial institution. Thus, the user can transfer funds from more than one financial account using a single registered phone. In addition, using a phone, whether a mobile phone or land-line telephone, for the payment process can eliminate the risk of spyware compared to Internet-based EFT systems. Furthermore, for asynchronous transactions, the payer and the payee need not be in direct communication during a funds transfer. Also, no special hardware or software application is needed on the phone device, and the phone device does not store funds.

Furthermore, a payer can pay bills without having to log in to the merchant's website each time to authorize the payment or sign-up for automatic withdrawals from the payer's bank account, which people are typically uncomfortable doing when the amount is not fixed. Additionally, banks save the variable (marginal) cost of processing a check. Banks can reduce the maintenance and service cost of ATM machines, and ultimately, this payment method can replace cash.

Other aspects, features, and advantages will become apparent from the following detailed description, the drawings, and the claims.

### BRIEF DESCRIPTION OF THE DRAWINGS

FIG. 1 illustrates a block diagram of one implementation of the phone-based payment system.

FIG. 2 shows the types of funds transfers that can be conducted using the phone-based payment system.

FIG. 3 shows a registration process for the phone-based payment system.

FIG. 4 shows a funds transfer process initiated by a payer using the phone-based payment system.

FIG. 5 illustrates the interaction of the components of the phone-based payment system in a user-to-user funds transfer environment, where bank account information is stored on a central server.

FIG. 6 illustrates the interaction of the components of another implementation of the phone-based payment system in a user-to-user funds transfer environment, where bank account information is not stored on a central server.

FIG. 7A shows a funds transfer process initiated by the payee.

FIG. 7B shows funds transfer process based on the payment request of FIG. 7A.

FIGS. 8A & 8B illustrate the interaction of the components of the phone-based payment system in a user-to-business funds transfer environment.

Like reference symbols in the various drawings indicate like elements.

### DETAILED DESCRIPTION

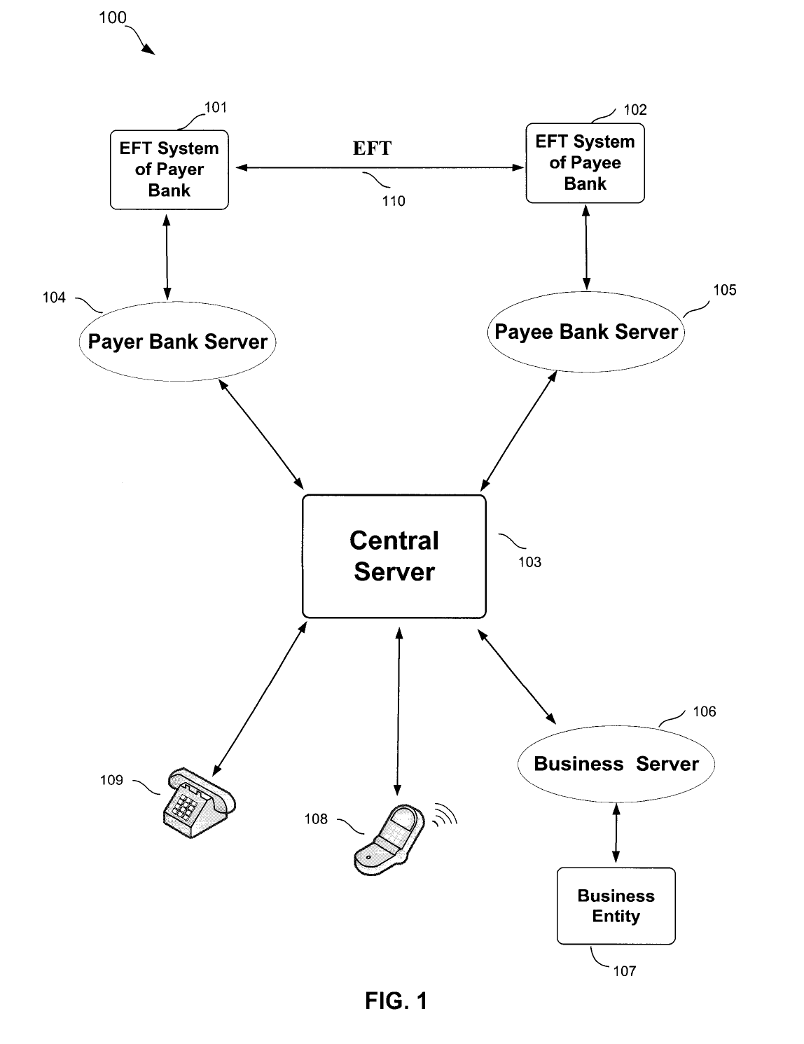

FIG. 1 illustrates a block diagram of a phone-based payment system 100 that can be used to carry out electronic funds transfer (EFT) from the EFT system of a payer bank 101 to the EFT system of a payee bank 102. The banks 101, 102 can be any financial institution, such as a savings & loan, credit union, a brokerage, mutual fund company, and insurance company. The central server 103 stores payer and payee records that are associated with payer and payee bank accounts and routes payment transactions. Each bank that is part of the phone-based payment system 100 (e.g., payer bank 101 and payee bank 102) is communicatively connected to the central server 103 by a bank server associated with the bank, such as payer bank server 104 and payee bank server 105. That is, payer bank 101 is associated with a payer bank server 104 and the payee bank 102 is associated with a payee bank server 105. The bank servers 104, 105 act as the bridge between the central server 103 and the EFT systems of the payer bank 101 and the payee bank 102 by exchanging transaction information with the central server 103, which can be comprised of one or more servers (hardware and/or software) associated with one or more databases arranged as a distributed network.

The central server 103 can also be communicatively connected to a business server 106, which can be an electronic device or a computer system located at a business entity 107, such as a utility company, an online vendor, or a retail location. The business entity 107 can send requests (e.g., electronic invoices, bills, or credits) to the central server 103 via the business server 106 to receive payments from its customers or issue refunds to its customers using the customers' phone numbers or other unique identifiers associated with the customers. In this instance, the business entity 107 can be considered a payee. Secure connections are used to connect the central server 103 to the bank servers 104, 105 and the business server 106. The secure connections can be based on a secure sockets layer (SSL) system, a public key infrastructure system, or other known encryption systems.

A user of the phone-based payment system 100, such as an individual or small business payer and payee (e.g., those payers and payees that do not have a business server 106), connect to the central server 103 by calling from mobile phone 108 or land-line phone 109. The phones 108, 109 are each uniquely associated with the user. The mobile phone 108 can be a cellular phone, smartphone, PDA or Blackberry that is registered with the central server 103. The landline phone 109 can be a telephone that is Caller ID-enabled and registered with the central server 103. Additionally, phones 108, 109 can be a voice-over-internet-protocol (VoIP) phone, such as those that can be used on systems provided by Vonage or Skype, or any other phone or communication device that has a unique identifier (e.g., a Caller ID) that is registered with the central server 103. The phones 108, 109 provide the interface for the user to connect and exchange information with the central server 103.

A user registers her phone, either mobile phone 108, land-line phone 109, or both with the central server 103 through her banks (and their associated bank server) with which she has an account, such as a checking, savings, credit card, brokerage, or mutual fund account, that she wishes to register with the payment system 100. Similarly, in this implementation, the user registers one account for each bank the user wants to be associated with her registered phone. That is, the user can register her phone with as many of her banks that she wishes, but can only register one account at each bank. In an alternative implementation, the user can register more than one account per bank and can optionally select one of those accounts as the main account for that bank. Additionally, the user can register another (or even the same) account located at the same bank with another registered phone if desired.

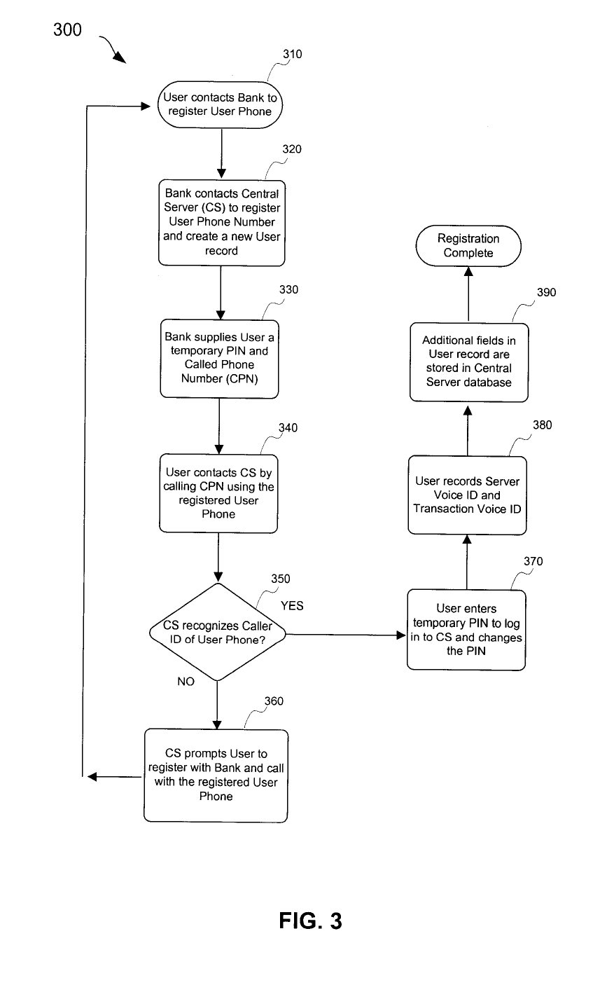

In one implementation, information indicating the registered account is stored at the bank at which the account is located. Alternatively, such information can also be stored in the central server 103. During operation, the user's bank(s) can be the payer bank 101 if the user is a payer in the transaction or the payee bank 102 if the user is the payee in the transaction. One example registration process is illustrated in FIG. 3 as described below. Similarly, a business entity 107 registers its business server 106 (e.g., receiving accounts) with the central server 103 through its associated bank just like any individual or small business user. However, in addition, the business server 106 can have a customized interaction with its customers by registering a customized functionality with the central server 103 independently and not through its bank.

A record for each registered account (i.e., the registered account for each selected bank), and in some implementations each business server account, is stored in the central server 103, such as in a database of central server 103. The information stored in each record can include the following fields: a) for a user record, the phone number (or other phone identifier) associated with the user's landline phone 109 or mobile phone 108 (i.e., the “registered phone number”), and, for a business server record, a unique business server number associated with the business server 106 (i.e., the “registered business server number”); b) a bank identifier (bank ID), such as a number, which identifies the bank associated with the user bank account or with the business server bank account and can be used to get the bank routing number for a transaction; c) a “primary flag” which indicates if the record reflects the primary (default) user bank account or business server bank account associated with the registered phone number or business server number stored in field (a) (among the potentially multiple records identified by field (b)); d) for a user record, a server voice identifier recorded by the user during registration, such as a voice message from the user herself; e) for a user or business server record, a transaction voice identifier recorded by the user or business server during registration, such as a voice message from the user herself or a message from the business entity associated with the business server; and f) an unencrypted (or optionally encrypted for added security) personal identification number (PIN), which can be used to authenticate the user as being the owner of the registered bank account.

In other implementations, the record associated with each user and business server account can include additional fields containing different information or fewer of the fields noted above (e.g., the record can include simply fields (a) and (b)) or different combinations of fields than the combination identified above. The central server 103 also stores a look-up table of a one-to-one mapping between pre-determined phone numbers used to connect to the central server 103 (i.e., “called phone numbers”) and bank IDs. That is, each bank has a corresponding “called phone number.” Thus, if a user wants to initiate a transaction using a desired registered bank account from or to which funds are transferred, the user makes a call with her registered phone to connect to the central server 103 by dialing the called phone number corresponding to the bank at which the registered bank account is located.

A bank account associated or registered with the payment system 100 can be uniquely identified by fields (a)+(b) or fields (a)+(c) of the user or business server records stored in the central server 103. For example, a payer's bank account can be identified by fields (a)+(b). When a payer calls the central server 103 using her landline phone 109 or mobile phone 108, the central server 103 receives the phone number of that phone making the call (i.e., the “received phone number”), which typically is the Caller ID, and identifies the phone number that the payer dialed to connect to the central server 103 (i.e., the “called phone number”). The central server 103 uses the received phone number (e.g., the Caller ID) to search field (a) of each record, which includes the registered phone number, for a corresponding match. The central server retrieves all records (each corresponding to a different bank) in which there is a corresponding match.

The central server 103 then uses the stored look-up table of called phone numbers to bank IDs to retrieve the bank ID that is associated with the called phone number that the user dialed to connect to the central server 103. This retrieved bank ID is then used to search the records that were retrieved based on the received phone number (e.g., the Caller ID) for a corresponding match in field (b). This results in a unique record from which payment will be made. Thus, the registered phone number (i.e., the information in field (a) of the record), if matched with the received phone number (e.g., the Caller ID), and the bank ID (i.e., the information in field (b) of the record), if matched with the bank ID obtained from the look-up table based on the called phone number, are used to retrieve the payer's record associated with the bank account from which payment will be made. If the central server 103 does not receive the called phone number information when the call is connected, then the central server 103 may ask the user to enter the bank ID to retrieve the relevant record to proceed further.

An operational overview of the phone-based payment system 100 can be illustrated with the following example. Suppose that Jim Smith has two bank accounts that he would like to register with payment system 100, one with Bank of USA and the other with American Bank. Each of these banks may at a later time be considered a payer bank 101 or payee bank 102 depending on Jim Smith's role in a particular transaction. Jim can register each of these bank accounts by contacting each bank, either by calling the bank, going to the bank in person or accessing the bank's website online. In this scenario, Jim Smith initiates and completes the entire registration process for each bank account by simply calling each bank and providing the bank account information, such as the bank account number, associated with the bank that he would like to register with the payment system 100.

Also during the call, Jim Smith provides the phone number associated with each of his phones that he intends to use with payment system 100, such as his home phone number, mobile phone number, and work phone number. For this example, Jim Smith intends to use only his mobile phone 108 and provides his mobile phone number—(123) 444-8888. Thus, the registered phone number for each registered bank account is Jim Smith's mobile phone number. That is, Jim Smith's registered bank account at Bank of USA is associated with his registered mobile phone number. Likewise, Jim Smith's registered bank account at American Bank is associated with the same registered mobile phone number.

In other implementations, Jim Smith can register another phone number, such as a home phone number, and have that number associated with the same bank account that was associated with his mobile phone number. At the time of registration, Jim is informed that he needs to call (600) 345-6789 to access his Bank of USA account (i.e., the pre-determined “called phone number” for Bank of USA) that is associated with his registered mobile phone number and to call (400) 778-1234 to access his American Bank account (i.e., the pre-determined “called phone number” for American Bank) that is also registered with his mobile phone number. Thus, at this point, Jim is a registered user, who can be identified by his Caller ID and registered phone number or other registered or personal information stored by the payment system 100.

Now, suppose Jim calls the phone number (400) 778-1234 from his registered mobile phone, which is the number associated with American Bank. From the received phone number (e.g., the Caller ID information), the central server 103 verifies that the received phone number matches with Jim's registered phone number—i.e., the phone number (123) 444-8888. The central server 103 also identifies the called phone number—i.e., the phone number (400) 778-1234—and retrieves the bank ID for American Bank from the lookup table that provides a one-to-one mapping of called phone numbers to bank IDs. Therefore, using just two fields stored in the central server 103, i.e., field (a), which contains the registered phone number (123) 444-888, and field (b), which contains the called phone number (400)778-1234, central server 103 can access Jim Smith's bank account at American Bank through American Bank's server. Depending on Jim's role in a particular transaction, American Bank's server can be the payer bank server 104 if Jim is a payer or the payee bank server 105 if Jim is the payee (and if field (c)=1 for his American Bank account).

Additionally, if Jim had called the phone number (600) 345-6789 from his registered mobile phone, then the central server 103 would have accessed Jim Smith's bank account at Bank of USA using field (a) (i.e., the registered phone number (123) 444-8888) and field (b) (i.e., the called phone number (600) 345-6789). If Jim had called either of the two bank phone numbers from an unregistered phone (i.e., a phone other than his mobile phone in this example), the central server 103 would not have been able to identify the received phone number based on the Caller ID of the unregistered phone. At this point, the central server 103 can inform Jim that the phone he called from is not a registered phone. Jim can then register the phone or call the central server 103 again using his registered mobile phone.

In the payment system 100, payee's accounts, i.e., the registered payee bank account, can be uniquely identified by fields (a) and (c). As an example, suppose Jim Smith designated one of his two accounts, say Bank of USA account, as the primary account associated with phone number (123) 444-8888. Then, the primary flag of field (c) in Jim's Bank of USA record is set to 1. In this implementation, for each registered phone number, only one account can be designated as the primary account. Now suppose another registered user, John Doe, wishes to pay or transfer funds to Jim Smith. To do that, John Doe calls the pre-determined “called phone number” associated with his bank, the payer bank 101. The central server 103 receives the Caller ID information and searches the database for a corresponding registered phone number based on the Caller ID information in order to verify that phone from which John Doe is using to make the call is a registered phone.

Once verified, John Doe can then select an option to make a payment or transfer funds by simply entering the payee's registered phone number. When John Doe enters Jim Smith's phone number—(123) 444-8888—as the payee, the central server 103 searches its database (i.e., the registered phone numbers contained in field (a) of the user records) to verify that the entered payee phone number is a registered phone number. After the central server 103 confirms that the entered number is Jim Smith's registered phone number, it can retrieve Jim Smith's primary account records by simply using fields (a)=(123) 444-8888 and field (c)=1 and access the payee bank server 105 identified from the bank ID field of the retrieved record. Thus, Jim Smith's bank account at Bank of USA (i.e., the payee bank 102) would be the unique match to accept John Doe's payment.

In addition to the fields (a) through (f) stored in the central server 103, there are at least two techniques for storing bank account numbers—option A and option B. With option A, the central server 103 stores the bank account number as a field in each record. This field can be encrypted for added security. With option B, the central server 103 does not store bank account numbers but queries for it from the relevant bank server as described above (e.g., payer bank server 104 or payee bank server 105) in each transaction through a secured connection. In both cases, however, the unique bank ID would allow the central server 103 to identify the relevant bank server and retrieve the bank routing number, thereby identifying the banks in the payment transaction.

Therefore, in a transaction that uses Option A, central server 103 can send the payer's and the payee's bank account information directly either to payer bank server 104, which initiates a “push” EFT 110 operation from payer's account at payer bank 101 to payee's account at payer bank 102, or to payee bank server 105, which initiates a “pull” EFT 110 operation from payer's account at payer bank 101 to payee's account 102. The terms “push” and “pull” specify respectively, if the payer's bank or the payee's bank initiates the transaction. If the payer uses her bank account to pay for the transaction, then the transactions are usually executed using the Automated Clearing House (ACH) network. A “pull” transaction is equivalent to what is called an ACH debit transaction, in with the payee bank withdraws funds from the payer's bank through an ACH operator. Collection of insurance payments, consumer bill payments, and loan payments are examples of ACH debit transactions. A “push” transaction is equivalent to what is called an ACH credit transaction, in which the payer's bank deposits funds into the payee's bank through an ACH operator. Payroll direct deposit, dividend and interest payments are examples of ACH credit transactions. If the payer uses a credit card to pay for the transaction, then typically, the merchant's bank (the acquiring bank) initiates the funds transfer from the payer's card-issuing bank. This is considered a “pull” transaction. A Wire Transfer transaction is initiated by the payer's bank, and is therefore considered a “push” transaction.

In a transaction that uses option B, central server 103 queries for the payee's account number from payee bank server 105 by sending to the bank server 105 the payee's registered phone number or unique business server number, and then forwards this information to the payer bank server 104, which then initiates a “push” EFT 110 from payer's account at payer bank 101 to payee's account at payee bank 102. Alternatively with option B, central server 103 queries for payer's account number from payer bank server 104, and then forwards this information to the payee bank server 105, which initiates a “pull” EFT 110 from payer's account at payer bank 101 to payee's account at payee bank 102. Options A and B can also be combined in a payment transaction when one bank in the transaction permits option A but the other bank permits only option B.

Both options A and B avoid storing account information at the merchant location, thereby decreasing the merchant's risk of losing information. This can also eliminate uncontrolled dissemination of account information, helping bank and credit card companies lower (and better manage) their risks. Even though the central server 103 and the bank Servers 104, 105 exchange information through secured network connections, option B enhances security even further by not storing bank account information in the central server 103. In addition to the fields discussed above, the central server 103 can store additional fields and tables.

With the phone-based payment system 100, a payer, such as an individual user, can transfer funds from her bank or credit account to a payee's bank account, whether the payee is another individual or a business entity and payee's bank account is at the same bank or a different bank as the payer's bank account, using a mobile phone 108, landline phone 109, or any phone which provides Caller ID information without having to know the account number of the payee. Moreover, no funds are stored by an intermediary, such as is done with intermediary based payment systems (e.g., Paypal) because with the phone-based payment system 100 the transfer of funds happens from the payer's bank/credit account directly to the payee's bank account. Additionally, with the phone-based payment system 100, no special hardware or software application is needed on the user's phone, and no funds typically need to be stored on the user's phone (i.e., the phone does not act as a stored value device). Payees that are business entities, such as utility companies, typically only need to register once with the central server 103 and can then have their customers (i.e., the payers in this case) route payments to them electronically by phone instead of having to write and send a paper check. These payees can send a request for payment periodically to their customers' account on the central server 103 using the customer's registered phone number as an identifier. The customer then can connect to the central server 103 using her mobile phone 108 or landline phone 109, whichever is registered, and authorize outstanding payment requests at her convenience, from whichever bank account she desires.

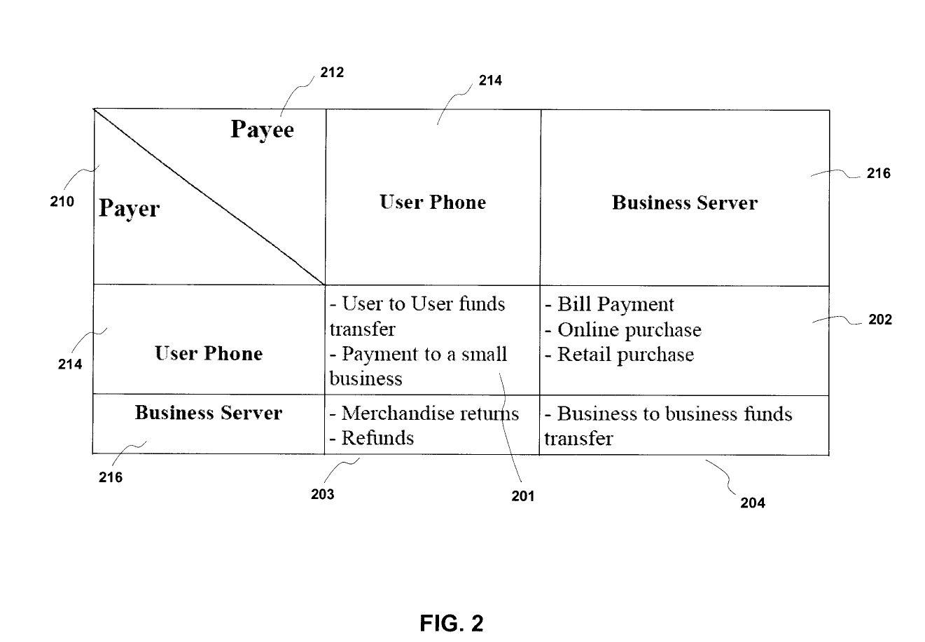

FIG. 2 shows the types of funds transfer transactions that can be conducted using the phone-based payment system 100. A transaction in the payment system 100 can be initiated by a payer 210 or payee 212, using either a registered user phone 214 or business server 216. As discussed above, a registered user phone 214 is the phone that a user registers with the central server, and a business server 216 is the server that a business entity registers with the central server. The user phone 214 and the business server 216 are the mechanisms by which payment transactions are initiated or completed.

For example, when both the payer 210 and the payee 212 initiate/complete transactions by registered user phones 214 (such as done by individuals or small business that do not have business servers), as shown in quadrant 201, the payment system 100 can be used for user to user funds transfer transactions, where each user uses her registered phone(s) to initiate or complete the transaction. Further, if the payer 210 has a registered user phone 214 (e.g., an individual) and the payee 212 has a business server 216 (e.g., a business entity), as shown in quadrant 202, the payment system 100 can be used to carry out bill payments, online purchases, or retail purchases. If the payer 210 has a business server 216 (e.g., a business entity) and the payee 212 has a registered user phone 214 (e.g., an individual), as seen in quadrant 203, the payment system 100 can be used to carry out merchandise returns and refunds. In the case where both payer 210 and payee 212 have business servers 216 (e.g., both are business entities), as seen in quadrant 204, the payment system 100 can be used for funds transfers between business entities.

FIG. 3 shows a registration process 300 for using the phone-based payment system. At 310, the user (e.g., the payer or payee) contacts the bank to register one or more of the user's phones and one or more of the user's bank accounts with the payment system. The user registers one or more of her phones by providing the phone number (or other identifier) associated with her phone. The term “bank” is used herein broadly to include banks, savings and loans, credit unions, credit card companies, mutual fund companies, brokerage firms, insurance companies and any other financial institutions. Contacting the bank can be carried out by phone, through the bank's website, or in person. The bank may verify that the phone number the user wants to register with the payment system is associated with user by, e.g., contacting and checking with telephone service providers. Next, at 320 the bank contacts the central server to create a new record including the entered user phone number and a retrieved bank ID associated with the bank. As discussed before, the bank ID has a one-to-one mapping with the called phone number for the bank and it is an identifier uniquely associated with the bank. The central server creates the new user record and returns to the bank a temporary PIN (which can be valid for a short period of time). At 330, the bank supplies the user this temporary PIN and the called phone number to call the central server and use a particular bank account associated with the bank.

Next, at 340, the user calls the central server from her registered phone by dialing the called phone number. At 350, the central server receives the call and Caller ID information and uses the Caller ID to determine whether in fact the phone used to call the central server is a registered phone. If the Caller ID is not recognized by the central server as being associated with a registered phone, at 360, the central server prompts the user to register the phone with her bank and call with a registered phone. On the other hand, if the central server recognizes the Caller ID as being associated with a registered phone, at 370, the central server asks the user for the temporary PIN. The user enters the temporary PIN previously provided by the bank, and once correctly entered, the central server prompts the user to change the temporary PIN to a permanent PIN of the user's choice.

To enhance security further, the PIN can, optionally, include a static and a dynamic component. The static component can be the permanent PIN chosen by the user, as described above. At the time of registration (or later), the user can also request the central server to provide her a dynamic PIN for every transaction. In this implementation of the PIN authentication process, the user enters the static as well as the dynamic components of the PIN to log in to her account. When the user connects to the central server using her registered phone, the central server plays the user's server voice identifier, which will be described in detail below. Then the central server asks the user if it should send her the dynamic component of the PIN to allow her to log in. The user responds in affirmative and hangs up. The central server immediately generates a number, which can be a random number or a pseudo-random number or another number, and designates this number as the dynamic component of the PIN for this user. Then the central server calls the user on her registered phone and lets her know this dynamic component of her PIN for the next transaction. The user then calls the central server again and logs in by entering both the static and the dynamic components of the PIN.

The dynamic component of the PIN can be valid for a single or a few connections or for a pre-determined period of time (e.g., one month) after it was created. If this dynamic PIN component expires, then the user has to request a new one by calling the central server. This method requires the user to make two phone calls to the central server to complete a transaction, but it can increase security. Although the static component is generally sufficient to protect a registered user from fraudsters who call the central server from another phone masquerading as the user's registered phone number (known as Caller ID spoofing), the dynamic component makes it difficult for a fraudster to log in even if he somehow gets the user's (static) PIN. This is because the central server calls the actual registered phone to divulge the dynamic PIN component. However, the dynamic PIN mechanism cannot protect the user from a situation in which the fraudster physically gets hold of the user's registered phone and, additionally, also knows the static component of user's PIN. If the user loses her registered phone, her best course of action is to report this immediately to the bank, which will suspend the registration. For the remainder of this description, a static implementation of PIN is used, that is, the PIN only comprises the permanent PIN chosen by the user.

Next at 380, the central server requests the user to record her server voice identifier and transaction voice identifier. The server voice identifier and transaction voice identifier are used as authentication components of the phone-based payment system 100. The server voice identifier, which is recorded in the user's own voice, is played to the user upon connection to the central server and before the user enters her permanent PIN. Thus, the server voice identifier can be used to authenticate the central server to the user before the user enters any confidential information. This feature protects the user from inadvertently dialing an unauthorized site and entering sensitive information, which can be misused (e.g., phishing scams). Also, use of the server voice identifier helps the user verify which bank account she is connected to for funds transfer purposes. Thus, the server voice identifier authenticates the central server to the user so that the user does not inadvertently divulge her permanent PIN or more information to an unauthorized third party.

The transaction voice identifier, a voice message either recorded in the payee's own voice or otherwise supplied by the payee (e.g. by a business entity), can be used to authenticate the payee to the payer before the payer authorizes the transaction. This authentication feature helps the payer verify that: 1) The payee is indeed registered in the phone-based payment system; 2) the payer did not make a mistake in entering the payee's registered phone number; and 3) the phone-based payment system has matched her funds transfer request with the correct payee bank account. The payer is responsible for verifying the server voice identifier and the transaction voice identifier. The payer simply listens to and recognizes the payee's voice or the information contained in the transaction voice identifier and decides whether she should proceed with the payment transfer. This prevents erroneous transfers due to the payer entering payee's registered phone number incorrectly.

As an example of how the server voice identifier and transaction voice identifier are used as authentication features, suppose that when Jim Smith registers his Bank of USA account, he records a short message, “Jim Smith, Bank of USA,” in his own voice as his server voice identifier and a short message, “Jim Smith, Boston Mass.,” in his own voice as his transaction voice identifier. When Jim Smith connects to the central server by dialing the called phone number (600) 345-6789 from his registered mobile phone number (123) 444-8888, the central server recognizes Jim's registered phone from the Caller ID, retrieves Jim's record, and plays “Jim Smith, Bank of USA” in Jim's voice, before requesting Jim to enter his permanent PIN. In addition, Jim could have also recorded “Jim Smith, American Bank” as his server voice identifier at the time of registering his American Bank account.

When John Doe enters Jim's registered phone number as the intended payee, the central server retrieves the record associated with Jim's primary bank account, which is his Bank of USA account, using field (a) (i.e., the registered phone number) and field (c) (the flag for setting the primary or default bank account). The central server then plays “Jim Smith, Boston Mass.” in Jim's voice to John Doe for verification by John Doe before he proceeds further with the transaction.

At 390, additional fields in the user record are stored in the central server database. For example, the user can designate his bank account as the primary account, which is stored in field (c) as discussed above. Although the user can designate or change his primary account (record) at any time (among his various registered accounts), one primary bank account is used per registered phone number. This primary bank account is the designated payee account associated for this user, i.e. it receives funds from payers. At this point, the registration process is complete and the user can utilize the payment system 100 to conduct funds transfer to and from this account.

In addition to registering a user's phones, process 300 also can be used to register business servers. As discussed before, a user's phones are typically associated with individuals or small business entities that do not require additional information on their invoices. On the other hand, business servers are used by business entities that require more detailed and ongoing interaction with the central server. A business server can be a software program that sends invoice information to the central server, receives payment confirmations, and facilitates internal processing of records. Further, a business server can be an electronic device with embedded instructions on how to communicate with the central server and process information received from the central server. The business server can contact the central server through a communications network such as a telephone network, a cellular network, a Wi-Fi network, a WiMAX network, an Internet network, a satellite network or combination of these networks.

A business entity requiring custom logic for a customized interface registers its business server in two stages. First, it registers its bank account with the central server, just like a user. Second, it registers its custom logic with the central server independently. A business server also has a unique number associated with it, similar to a user's registered phone number which is stored in field (a) in the central server database. The central server can distinguish from the value of field (a) if it belongs to a user or a business server. When the payer specifies a business server as the intended payee, the central server can run customized procedures, which allow the collection of additional information from the payer, such as an invoice number. This helps the business entity match the payment with the payer's records in its internal systems.

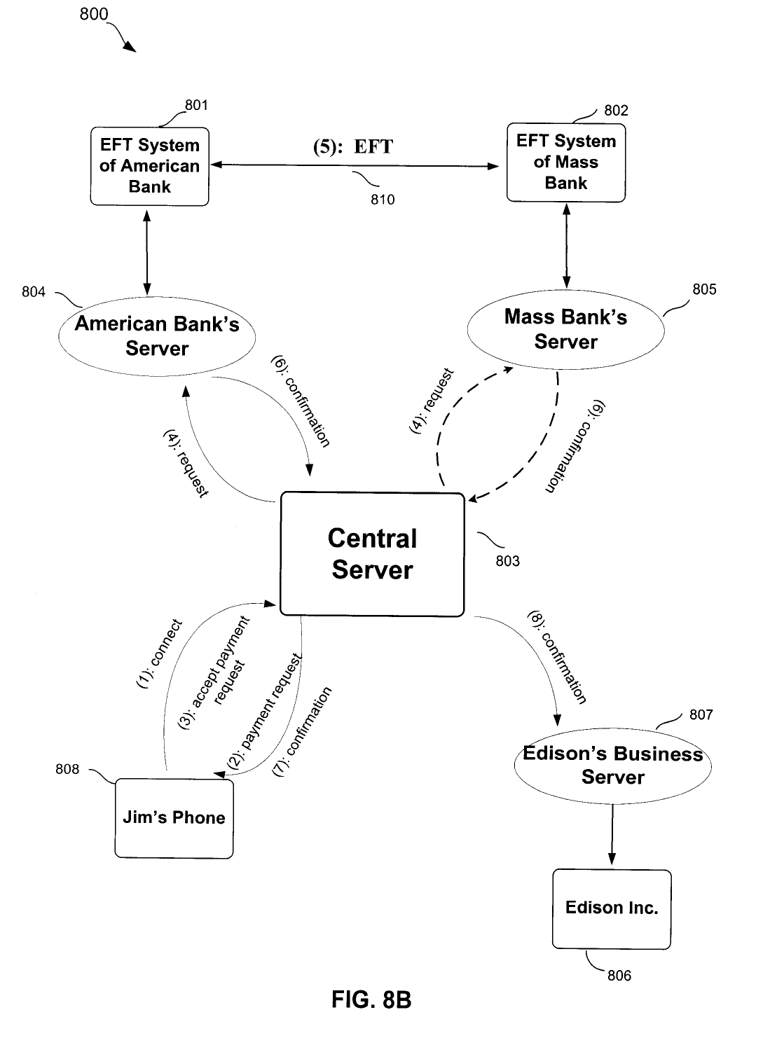

For example, suppose that an electric utility company (e.g., Edison Inc.) collects payments from its customers using the payment system 100 of FIG. 1. Edison Inc. is registered with the central server and has the unique number 999-000-2222 associated with it. Edison Inc. would like to know the Edison Inc. account number of the customer when the customer makes a payment so that it can match this with its internal records. When Edison Inc.'s customers enter 999-000-2222 as the payee identifier, the center server recognizes this account as associated with a business server. As will be described with respect to FIG. 8 below, the process flow calls a custom logic designed specifically per Edison Inc.'s requirements. In this case, the user would hear Edison Inc.'s transaction voice identifier and then, in a custom logic part, is requested to enter his Edison Inc. account number. All information is sent to the Edison Inc.'s business server, which processes it and credits the customer's account. Alternatively, in a transaction initiated by the business server, as will be described in FIG. 8, Edison Inc.'s business server sends payment requests to the central server, which posts it to the user's registered bank account. The business server can attach customized information such as an invoice number or the user's Edison Inc. account number along with the payment amount in this request, so the user only has to authorize the transaction, and the payment can automatically be matched with her account in Edison Inc.'s internal processing systems.

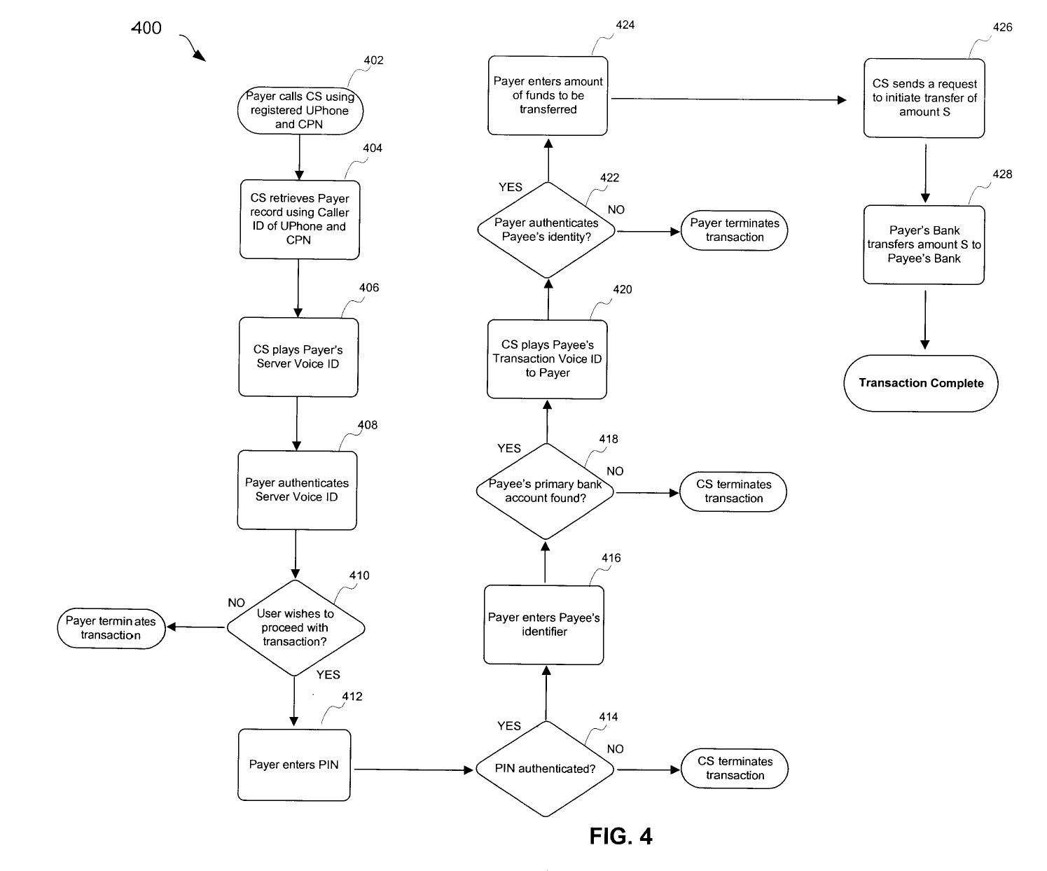

FIG. 4 shows a funds transfer process 400 initiated by a payer using the phone-based payment system. At 402, using the payer's registered user phone (UPhone), the payer can connect to the center server (CS) by calling the phone number associated with her bank account (i.e., the called phone number (CPN)). At 404, from the Caller ID of the registered user phone and the called phone number, the central server retrieves the payer's record(s) in its database. At 406, if the payer record is found, then the central server plays the payer's server voice identifier (Server Voice ID). At 408, the payer authenticates the server voice identifier by recognizing his own previously recorded voice message (e.g., “Jim Smith, Bank of USA”). At 410, the central server prompts the payer to proceed by entering his PIN or to terminate the transaction. If the server voice identifier is not authenticated, e.g., because the payer does not recognize the recorded voice message, the payer may terminate the transaction. In such case, the called phone number may have been compromised and the payer may also want to alert the bank. In one implementation, authentication of the server voice ID can be done explicitly by pressing a key to continue the transaction. In another implementation, authentication of the server voice ID can be done implicitly by the user's entering the PIN upon hearing the server voice ID.

At 412, if the payer acknowledges his own server voice identifier and wishes to proceed, the payer enters his PIN. At 414, the central server authenticates the entered PIN by matching it with the stored PIN in the payer's record. The central server allows the payer to log in if the PIN is authenticated; conversely, the transaction is terminated if the PIN is not authenticated after a set number of attempts (e.g., three attempts) has been exhausted. At 416, the central server then prompts the payer to enter the payee's identifier (e.g., a registered phone number if the payee is an individual or small business user or a similar identifier if the payee is a business entity having a business server). At 418, after the payer enters the payee's identifier, the central server then tries to retrieve the primary account for the payee from its database. If the payee's identifier does not match any record, then the payer may be prompted to enter the identifier again. Eventually, the central server can terminate the transaction after a set number of attempts (e.g., three attempts) at entering the payee identifier.

At 420, after the central server successfully retrieves the payee's record(s), the central server then plays the payee's transaction voice identifier (ID) to the payer. At 422, the payer authenticates the identity of the payee, e.g., by either recognizing the voice of the payee or recognizing the information contained in the transaction voice ID (e.g., “Jim Smith, Boston Mass.”). If the payee's identity is not authenticated, the payer may terminate the transaction. On the other hand, once the payee's identity is authenticated, the central server prompts the payer to enter the amount of funds to transfer. At 424, the payer enters the amount to transfer to the payee, such as $500, which is reflected as an amount “S”, but the amount “S” can be any amount the payer is authorized to transfer. At this point, the central server prompts the payer to confirm the amount “S” entered, e.g., by asking the payer if the amount “S” is correct. Upon confirmation of the amount “S” by the payer, the central server retrieves the payer's and payee's bank account numbers.

At this point, there are two techniques described herein to store bank account numbers—option A and option B, as discussed above. With option A, the bank account numbers are available in the payer's and payee's respective records because they are stored in the database of the central server. With option B, the central server queries both the payer's and payee's bank servers for the bank account numbers. Alternatively, the central server may query one of the bank account numbers from the relevant bank server but retrieve the other bank account number directly from the record. At 426, the central server then sends a request to transfer the amount “S” to the payee's bank account in a push or pull transaction. For example, in a push transaction, this payment request is sent to the payer's bank server to transfer funds to the payee's bank by EFT. Additionally, the payee bank's routing number information, which can be obtained using the payee's bank ID field (e.g., field (b)) also can be transmitted. The payer's bank server then sends the request to its EFT system. On the other hand, in a pull transaction, the payment request is sent to the payee's bank server to withdraw funds from the payer's bank. At 428, the amount “S” is transferred electronically from the payer's bank account to the payee's bank account.

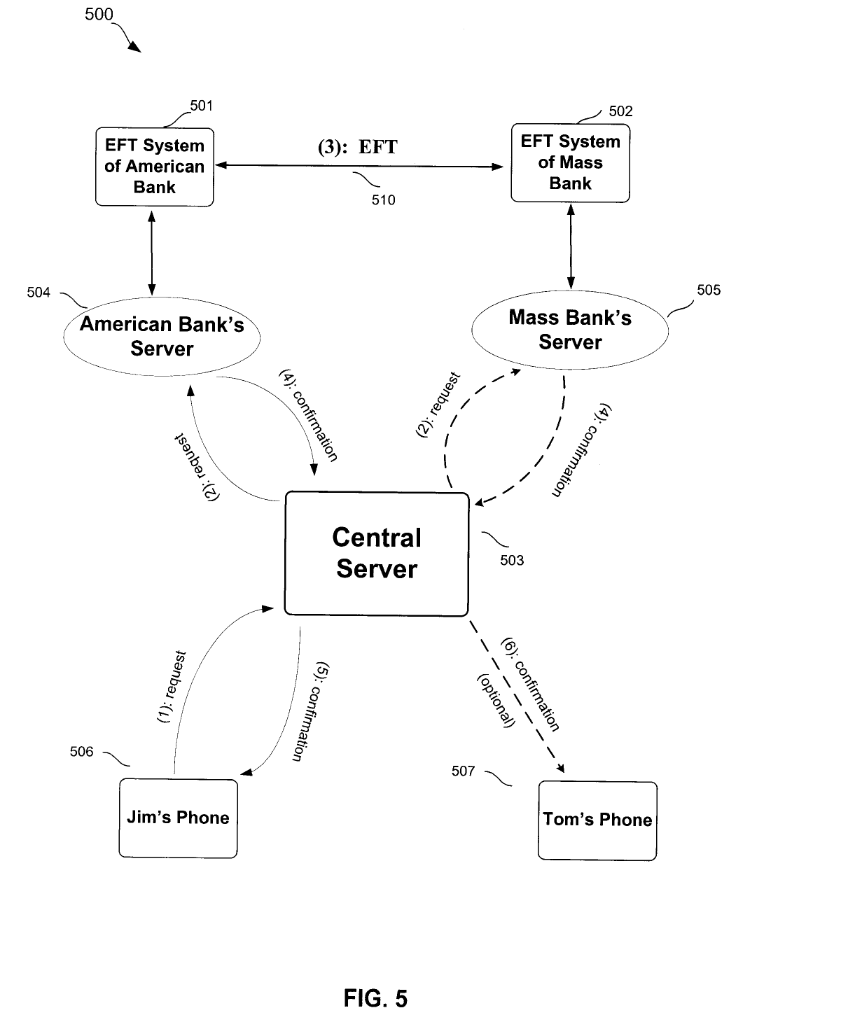

FIG. 5 illustrates the interaction of the components of a phone-based payment system 500 in a user-to-user funds transfer environment, where bank account information is stored on a central server, such as with option A discussed above. The payment system 500 is used to carry out an EFT 510 from the EFT system of American Bank 501 to the EFT system of Mass Bank 502. Both banks 501, 502 are connected to a central server 503 by a corresponding bank server 504, 505. Since payment system 500 uses option A, the central server 503 stores both the payer's and the payee's bank account numbers. Initially, Jim (i.e., the payer) contacts the central server 503 using his registered user phone 506 to make a payment to Tom (i.e., the payee).

The central server 503 then sends a payment request for funds transfer in a push or pull transaction. In a push transaction, the payment request is sent to the American Bank's server 504 along with Jim's American Bank account number and Tom's Mass Bank routing number and account number. The American Bank's server 504 then communicates this payment request to the EFT system of American Bank 501. Optionally, in a pull transaction, the payment request can be sent to the Mass Bank's server 505. In this case, the EFT system of Mass Bank 502 initiates the EFT with the EFT system of American Bank 501 by requesting payment. Upon receiving confirmation from either the American Bank 501 (in a push transaction) or the Mass Bank 502 (in a pull transaction) that the payment transaction has been initiated, the American Bank's server 504 or the Mass Bank's server 505 confirms this to the central server 503, which in turn confirms the payment request to Jim's user phone 506, such as through a status update on the transaction. Further, once the transaction is completed, the relevant bank server 504 or 505 can send another confirmation to the central server 503, which in turn communicates this to Jim's user phone 506. Optionally, the central server 503 can also send a payment confirmation to Tom's user phone 507. Additionally, both Jim and Tom can see this transaction in their bank statements.

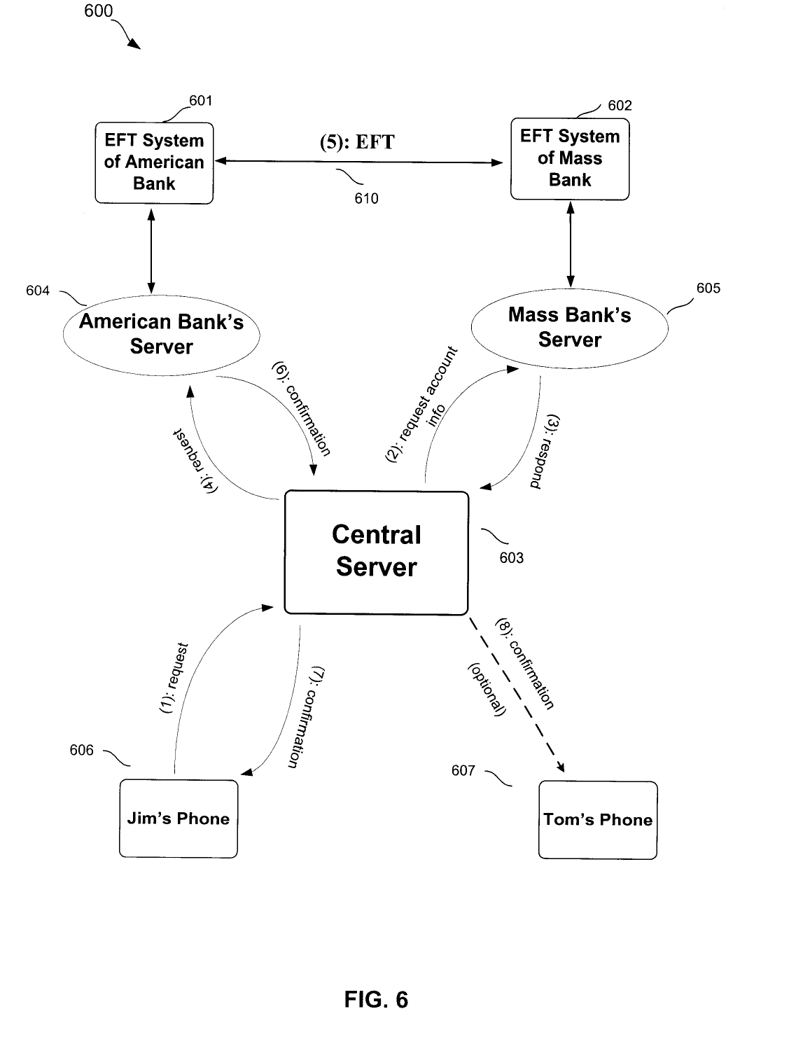

FIG. 6 illustrates the interaction of the components of another phone-based payment system 600 in a user-to-user funds transfer environment, where bank account information is not stored on a central server, such as with option B as discussed above. The payment system 600 is used to carry out an EFT 610 from the EFT system of American Bank 601 to the EFT system of Mass Bank 602. Both banks 601, 602 are connected to a central server 603 by a corresponding bank server 604, 605. The bank servers are identified from the bank ID associated with the payer's and payee's records. Here the central server 603 has to retrieve the payee's bank account number (or other information) from the payee's bank server, and then forward this to the payer's bank server to initiate the funds transfer. Initially, Jim (i.e., the payer) contacts the central server 603 using his registered user Phone 606 to make a payment to Tom (i.e,. the payee). As the central server 603 does not store Tom's bank account number in this implementation, the central server 603 requests this information from the Mass Bank's server 605 by sending it Tom's registered user phone number. Once the entered user phone number is verified by the Mass Bank's server 505 to be Tom's registered user phone number, the Mass Bank's server 505 responds to the central server 603 with Tom's bank account number at Mass Bank.

The central server 603 then sends a payment request for funds transfer in a push transaction. In a push transaction, the payment request is sent to the American Bank's server 604 along with Jim's registered user phone number and Tom's Mass Bank account information. The American Bank's server 604 retrieves Jim's bank account information from Jim's registered user phone number, and then sends a payment request with both Jim's and Tom's bank account information to the EFT system of American Bank 601. Upon receiving confirmation from the American Bank 601 that the payment transaction has been initiated, the American Bank's server 604 confirms this to the central server 603, which in turn confirms the payment request to Jim's registered user phone 606, such as through a status update on the transaction. Further, once the transaction is complete, the American Bank's server 604 can send another confirmation to the central server 603, which in turn can communicate this to Jim's registered user phone 606. Optionally, the central server 603 can also send a payment confirmation to Tom's registered user phone 607. Additionally, both Jim and Tom can see this transaction in their bank account statements.

The same payment could have been completed in a pull transaction, in which the Mass Bank 602 initiates the EFT 610 with the EFT of American Bank 601 by requesting payment. For this, the central server 603 retrieves Jim's bank account number at the American Bank from the American Bank's server 604, and then sends Jim's bank account number and Tom's registered phone number for the Mass Bank to the Mass Bank's server 605, which then retrieves Tom's bank account number and forwards the request to the EFT system of the Mass Bank 602.

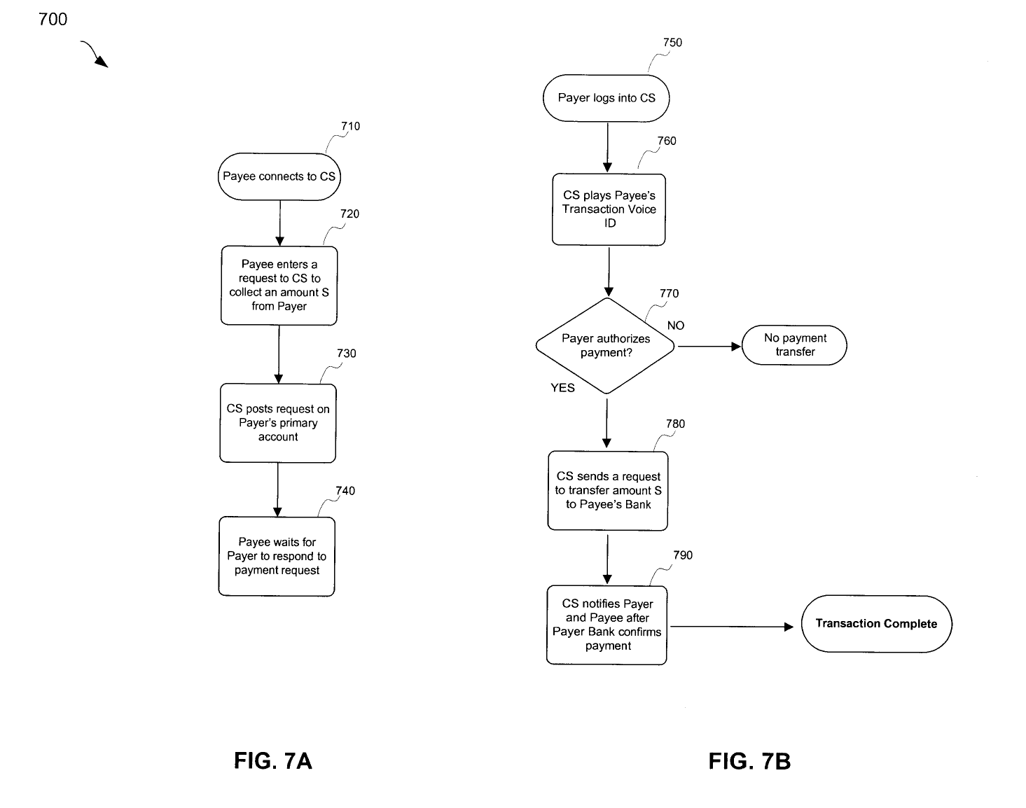

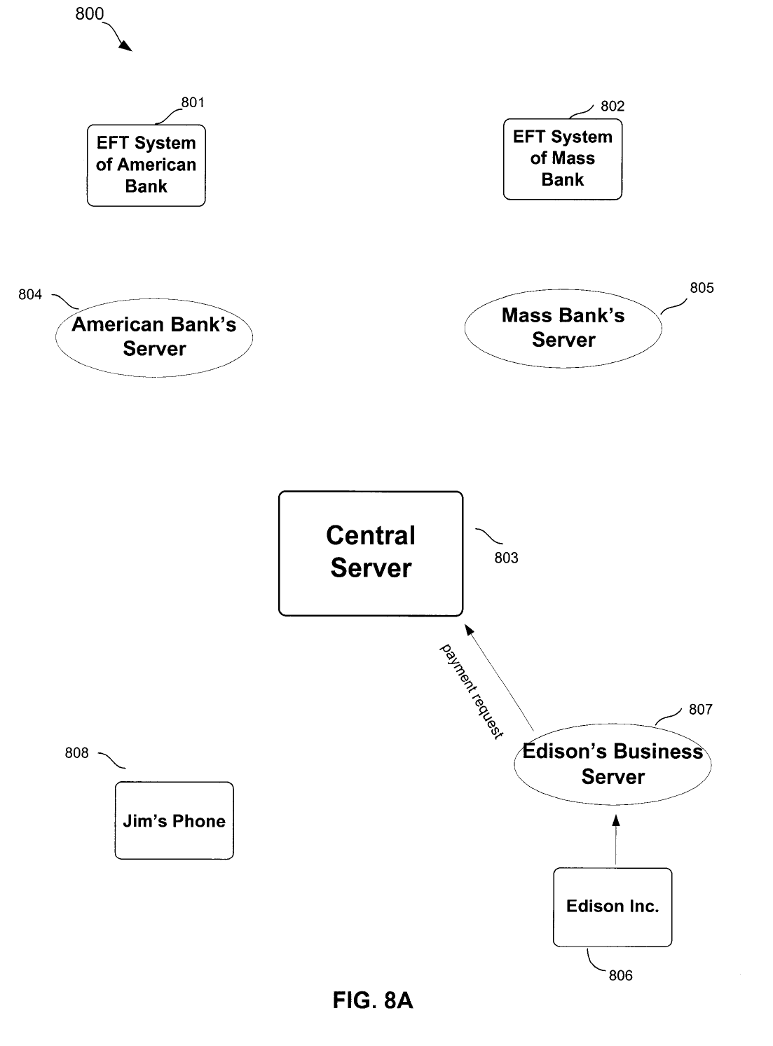

FIGS. 7A & 7B are flow charts showing a process 700 of a funds transfer initiated by the payee. As shown in FIG. 7A, at 710, if the payee is a business entity having a business server, then the payee connects to the central server using a computer software application or an electronic device connected through a communications network, such as a computer network, a telephone network, a cellular network, a Wi-Fi network, a WiMAX network, an Internet network, a satellite network or a combination of these networks. If the payee is an individual or small business user (e.g., those users that do not have a business server), then the payee connects to the center server by calling from her registered user phone the phone number associated with her bank account (i.e., called phone number (CPN)). At 720, using the payer's registered phone number as the payer identifier, the payee sends a request to the central server to collect an amount “S” from the payer. If the payee is a business entity with a business server, extra information such as an invoice number and a due date may also be sent to the central server along with the payment request. At 730, using the payer's registered phone number, the central server posts the payment request on the payer's primary bank account. At 740, the payee then waits for the payer to respond to the payment request.

As shown in FIG. 7B, at 750, when the payer connects to the central server (e.g., at a later time and at his convenience) by calling the called phone number of his bank at which his primary bank account is located, the central server informs the payer of the payee's payment request. Optionally, even if the payer does not log into his primary account, the central server can also inform the payer that a payment request has been made by the payee, and the payer can authorize the payment from this non-primary account. At 760, the central server plays the payee's transaction voice identifier (ID) for the payer's authentication. At 770, if the payer authenticates the payee's transaction voice ID, the payer can authorize the payment request. However, if the transaction voice ID is not authenticated, no payment transfer occurs.

At 780, the central server sends a request to transfer the amount “S” to the payee's bank account. In one implementation, authentication of the transaction voice ID can be done explicitly by pressing a key to continue the transaction. In another implementation, authentication of the transaction voice ID can be done implicitly by the user's entering an amount “S” upon hearing the transaction voice ID. As discussed earlier, this payment request can be a push or a pull transaction. For example, in a push transaction, this payment request is sent to the payer's bank server to transfer funds to the payee's Bank by EFT. On the other hand, in a pull transaction, this payment request is sent to the payee's bank server to withdraw funds from the payer's Bank. At 790, after the payer's (or payee's) Bank sends the central server a confirmation of success of the transaction, the central server sends a confirmation of the payment to both the payer and the payee.

If the payee is a business server, it can use this confirmation, which also includes the additional invoice information sent in the original request, to credit the payer's account. An example of such a payee is a utility company which has subscribed to the payments system. The utility company has its customers' registered user phone numbers. Using this information, the utility company sends to the central server bills to each of its customers, using its customers' registered user phone numbers, in each billing cycle, with the amount due and the payment due date. Customers periodically check their account by calling the central server. Alternatively, the central server can alert customers when a bill arrives by sending a text or SMS message, leaving an automated voice message or sending an e-mail. When the customer calls in, using her registered user phone, she is prompted that a payment is due by a particular due date to the utility company. The user is prompted to authorize the transaction. The user can authorize the transaction by simply pressing a key on her registered user phone, at which point the transfer of funds is initiated.

FIGS. 8A & 8B illustrate the interaction of the components of a phone-based payment system 800 in a user-to-business funds transfer environment. The payment system 800 is used to carry out an EFT 810 from the EFT system of American Bank 801 to the EFT system of Mass Bank 802. Both banks 801, 802 are connected to a central server 803 by a corresponding bank server 804, 805. FIG. 8A depicts an implementation of the payment system 800 in which option A for storing bank account numbers as discussed above is used (i.e., the central server 803 keeps records of both the payer's and the payee's bank account numbers). Here, Edison Inc. (i.e., the payee) 806 periodically sends out payment requests to all its customers for whom it has their registered phone numbers. This is done by Edison Inc.'s business server 807 contacting the central server 803 and posting payment requests (e.g., bills), as discussed above in more detail associated with the payment process 700. The business server 807 contacts the central server 803 using a computer software application through a network connection, such as a computer network, telephone network, a cellular network, a Wi-Fi network, a WiMAX network, an Internet network, a satellite network or combination of these networks. Each payment request can include the amount due, due date, and the customer's account number with Edison Inc.

As shown in FIG. 8B, at a later time, e.g., when Jim (i.e., the payer) connects to the central server 803 using his registered user phone 808 either at his convenience or after receiving a payment request alert from the central server 803, Jim is informed of the payment request from Edison Inc. 806. By pressing one or more buttons on his registered user phone 808, Jim can accept Edison Inc.'s payment request, at which point the payment of the payment request is authorized and a funds transfer is initiated. When Jim's bank server (e.g., the American Bank's server 804 in a push transaction) or Edison Inc.'s bank server (e.g., Mass Bank's server 805 in a pull transaction) informs the central server 803 of the successful completion of the transaction, the central server 803 forwards this confirmation to Edison Inc.'s business server 807. The confirmation can include the amount paid and Jim's account number with Edison Inc. 806. Edison Inc.'s business server 807 can pass this information to Edison Inc. 806 so that its internal accounting systems can update Jim's account at Edison Inc. 806 to reflect the received payment.

Another application of the payee-initiated method is an online purchase by a customer. For example, Jim purchases a digital camera from an online merchant Abc.com which has a business server registered with the central server 803. At the time of checkout, Jim provides his registered user phone number to Abc.com so that it can initiate the payment process. Abc.com sends a payment request to the central server 803 using Jim's registered user phone number that Jim provided to Abc.com, the amount due, and the invoice number, for example. Jim connects with the central server 803 using his registered user phone 808 by dialing the called phone number of the bank at which his credit card or bank account that he wishes to pay with is located. The central server 803 informs Jim of the pending request from Abc.com. By pressing one or more keys or buttons on his registered user phone 808 as prompted by the central server 803, Jim can authorize payment of Abc.com's payment request. As soon as the central server 803 receives confirmation that the transaction has been completed from Abc.com's bank, the central server sends this confirmation to Abc.com's business server, which can process the order further.

Another example of the payee-initiated method is a transaction at a physical point-of-sale location in a retail store. During checkout, the customer provides his registered user phone number to the retail employee performing the checkout. The employee enters this registered phone number into a computer software application or an electronic device at the employee's check-out terminal (e.g., a business server), which is connected to the central server, and sends a payment request for the amount due. The central server receives the payment request, and can optionally alert the customer of the payment request. The customer calls the central server by dialing the called phone number of the bank at which the credit card or bank account he wishes to use to make payment is located, and authorizes the payment. As soon as the central server receives confirmation of the transaction from the relevant bank server, the central server sends this confirmation to the employee's check-out terminal (e.g., the business server) that initiated the transaction. Upon receipt of this confirmation, the employee completes the checkout.

Various implementations of the subject matter described herein can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “memory” comprises a “computer-readable medium” that includes any computer program product, apparatus and/or device (e.g., magnetic discs, optical disks, RAM, ROM, registers, cache, flash memory, and Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

While many specifics implementations have been described, these should not be construed as limitations on the scope of the subject matter described herein or of what may be claimed, but rather as descriptions of features specific to particular implementations. Certain features that are described herein in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Although a few variations have been described in detail above, other modifications are possible. Accordingly, other implementations are within the scope of the following claims. For example, the actions recited in the claims can be performed in a different order and still achieve desirable results.

1-25. (canceled)

26. A coating liquid for an outermost layer of an electrophotographic photoreceptor, comprising:
a filler;
an organic compound having an acid value of from 10 to 700 mgKOH/g, the organic compound being a saturated or unsaturated fatty acid;
a binder resin; and
plural organic solvents.

27. The coating liquid according to claim 26, prepared by mixing the filler, the organic compound, the binder resin and plural organic solvents using a ball mill containing alumina balls.

28-46. (canceled)

47. The coating liquid according to claim 26, wherein the organic compound is selected from the group consisting of lauric acid, stearic acid, arachidic acid, behenic acid, adipic acid, oleic acid, maleic acid and salicylic acid.

48. The coating liquid according to claim 26, wherein the filler is an inorganic filler.

49. The coating liquid according to claim 48, wherein the inorganic filler is a metal oxide.

50. The coating liquid according to claim 26, wherein the filler is a hydrophilic metal oxide.

51. The coating liquid according to claim 26, wherein the filler is a basic filler.

52. The coating liquid according to claim 26, wherein the filler is alumina, zirconia, titanium oxide or silica.

53. The coating liquid according to claim 26, wherein the filler is a powder of a metal, tin oxide doped with antimony, indium oxide doped with tin, a metal fluoride, potassium titanate or boron nitride.

54. The coating liquid according to claim 26, wherein the filler has a resistivity not less than 10¹⁰ Ω·cm.

55. The coating liquid according to claim 26, wherein the filler has a surface that is treated with a surface treating agent.
